(19) United States
(12) Patent Application Publication
(10) Pub. No.: US 2026/0154997 A1
(43) Pub. Date: Jun. 4, 2026

(54) METHOD AND APPARATUS FOR PROVIDING VEHICLE INFORMATION, AND VEHICLE SYSTEM INCLUDING SAME

(71) Applicants: HYUNDAI MOTOR COMPANY, Seoul (KR); KIA CORPORATION, Seoul (KR); INHA UNIVERSITY RESEARCH AND BUSINESS FOUNDATION, Incheon (KR)

(72) Inventors: Dae Kwang Kim, Hwaseong-si (KR); Min Soo Woo, Hwaseong-si (KR); Seung Jun Yoo, Incheon (KR); Byung Wook Kim, Seongnam-si (KR); Min Woo Gwon, Daejeon (KR); Kwang Ki Kim, Incheon (KR); Ji Won Kim, Incheon (KR)

(73) Assignees: HYUNDAI MOTOR COMPANY, Seoul (KR); KIA CORPORATION, Seoul (KR); INHA UNIVERSITY RESEARCH AND BUSINESS FOUNDATION, Incheon (KR)

(21) Appl. No.: 19/200,190

(22) Filed: May 6, 2025

(30) Foreign Application Priority Data
Dec. 2, 2024 (KR) 10-2024-0176745

(51) Int. Cl. G07C 5/02; B60L 58/12; G01C 21/34

(52) U.S. Cl. CPC G07C 5/02; G01C 21/3469; B60L 58/12

(57) ABSTRACT

A method for providing vehicle information, performed by a computing device including a processor and a storage medium storing instructions executable by the processor, includes receiving destination information of a vehicle and target state of charge (SoC) information of a battery included in the vehicle at a destination, collecting travel environment information on a travel route determined based on the destination information, determining a charging plan establishment condition, based on the target SoC information and the travel environment information, and generating charging plan information for the travel route when the charging plan establishment condition is satisfied.

### CROSS-REFERENCE TO RELATED APPLICATION(S)

This application claims benefit of priority to Korean Patent Application No. 10-2024-0176745 filed on Dec. 2, 2024 in the Korean Intellectual Property Office, the disclosure of which is incorporated herein by reference in its entirety.

### TECHNICAL FIELD

The present disclosure relates to a method and apparatus for providing information for a vehicle, and a vehicle system including the apparatus and performing the method.

### BACKGROUND

Recently, a lot of development has been conducted on electric vehicles (EVs) or hybrid electric vehicles (HEVs) including batteries and electric motors.

The charging/discharging efficiency of a battery included in a vehicle may be different for each battery due to unique properties of the battery, and may also vary, depending on a state of charge (SoC) of the battery.

When traveling on a route farther than a distance to empty (DTE) of a battery of a vehicle, it may be necessary to charge the battery at a charging station located on the travel route.

In the related art, a relatively long period of time may be required to charge a battery, and therefore there may be difficulties in that a user may need to unnecessarily waste a long period of time during charging time or to select a charging station by searching for a location of a proper charging station, separately from a travel route.

### SUMMARY

An aspect of the present disclosure provides a method and apparatus for providing vehicle information, which are capable of generating and providing charging plan information, based on a preset rule, to improve user convenience and efficiency, and a vehicle system including the apparatus or performing the method.

Another aspect of the present disclosure provides a method and apparatus for providing vehicle information, which are capable of generating charging plan information, satisfying a target state of charge (SoC) at a destination received from a user, and a vehicle system including the apparatus or performing the method.

Another aspect of the present disclosure provides a method and apparatus for providing vehicle information, which are capable of providing charging plan information applicable to an actual travel situation in comprehensive consideration of driving energy of a vehicle derived or determined based on a motion equation of the vehicle and auxiliary energy consumed by other components of the vehicle, and a vehicle system including the apparatus or performing the method.

Another aspect of the present disclosure provides a method and apparatus for providing vehicle information, which are capable of reducing a computational load of a system by generating and providing charging plan information using a preset rule-based algorithm, and a vehicle system including the apparatus or performing the method.

The aspects of the present disclosure provide a method and apparatus for providing vehicle information, and a vehicle system including the apparatus or performing the method.

According to an aspect of the present disclosure, a method for providing vehicle information, performed by a computing device including a processor and a storage medium storing instructions executable by the processor, includes: receiving destination information of a vehicle and target SoC information of a battery included in the vehicle at a destination; collecting travel environment information on a travel route determined based on the destination information; determining a charging plan establishment condition, based on the target SoC information and the travel environment information; and generating charging plan information for the travel route when or based on that the charging plan establishment condition is satisfied.

According to another aspect of the present disclosure, an apparatus for providing vehicle information includes a processor and a storage medium storing instructions executable by the processor. The processor is configured, by executing the instructions, to: receive destination information of a vehicle and target SoC information of a battery included in the vehicle at a destination; collect travel environment information on a travel route determined based on the destination information; determine a charging plan establishment condition, based on the target SoC information and the travel environment information; and generate charging plan information for the travel route when or based on that the charging plan establishment condition is satisfied.

According to another aspect of the present disclosure, a vehicle system includes a battery, a display, an input module, and a processor. The processor is configured to: display (or cause to display) a user interface receiving destination information of a vehicle and target SoC information of the battery at a destination through the display; collect travel environment information on a travel route determined based on the destination information; determine a charging plan establishment condition, based on the target SoC information and the travel environment information; generate charging plan information for the travel route when or based on that the charging plan establishment condition is satisfied; and display (or cause to display) the charging plan information through the display.

According to embodiments of the present disclosure, in a method and apparatus for providing vehicle information, and a vehicle system including the apparatus or performing the method, charging plan information may be generated and provided based on a preset rule to improve user convenience and efficiency.

In the method and apparatus for providing vehicle information, and the vehicle system including the apparatus or performing the method, charging plan information, satisfying a target SoC of a destination received from a user, may be generated.

In the method and apparatus for providing vehicle information, and the vehicle system including the apparatus or performing the method, charging plan information applicable to an actual travel situation may be provided in comprehensive consideration of driving energy of a vehicle derived based on a motion equation of the vehicle, and auxiliary energy consumed by other components of the vehicle.

In the method and apparatus for providing vehicle information, and the vehicle system including the apparatus or performing the method, a computational load of a system may be reduced by generating and providing charging plan information using a preset rule-based algorithm.

### BRIEF DESCRIPTION OF DRAWINGS

The above and other aspects, features, and advantages of the present disclosure should be more clearly understood from the following detailed description, taken in conjunction with the accompanying drawings, in which:

FIG. 1 is a block diagram illustrating a vehicle system according to an embodiment of the present disclosure;

FIG. 2 is a flowchart illustrating a vehicle information providing method according to an embodiment of the present disclosure;

FIG. 3 is a flowchart illustrating a vehicle information providing method according to an embodiment of the present disclosure;

FIG. 4 is a diagram illustrating a method for calculating energy consumed when a vehicle travels in a vehicle information providing method according to an embodiment of the present disclosure;

FIG. 5 is a diagram illustrating a method for generating charging plan information on a travel route in a vehicle information providing method according to an embodiment of the present disclosure;

FIG. 6 is a diagram illustrating a method for generating charging plan information on a travel route in a vehicle information providing method according to an embodiment of the present disclosure;

FIG. 7 is a diagram illustrating a method for generating charging plan information on a travel route in a vehicle information providing method according to an embodiment of the present disclosure;

FIG. 8A illustrates a screen on which charging plan information, generated by a vehicle information providing method according to an embodiment of the present disclosure, is provided;

FIG. 8B illustrates a screen on which charging plan information, generated by a vehicle information providing method according to an embodiment of the present disclosure, is provided; and

FIG. 9 is a block diagram illustrating a computing device capable of fully or partially implementing a vehicle system according to an embodiment of the present disclosure.

### DETAILED DESCRIPTION

Hereinafter, embodiments of the present disclosure are described with reference to the accompanying drawings. The following detailed description is provided to aid in a comprehensive understanding of a method, an apparatus, and/or a system described in the present disclosure. However, the detailed description is for illustrative purposes only, and the present disclosure is not limited thereto.

In describing embodiments of the present disclosure, when it is determined that a detailed description of a known technology related to the present disclosure may unnecessarily obscure the gist of the present disclosure, the detailed description thereof has been omitted. In addition, terms to be described below are terms defined in consideration of functions in the present disclosure, which may vary depending on intention or custom of a user or operator. Therefore, the definition of these terms should be made based on the contents throughout the present disclosure. The terminology used herein is for the purpose of describing particular embodiments only and is not to be limiting of the embodiments. As used herein, the singular forms “a,” “an,” and “the” are intended to include the plural forms as well, unless the context clearly indicates otherwise. As used herein, the term “and/or” includes any one and any combination of any two or more of the associated listed items. It should be further understood that the terms “comprises” and/or “comprising,” when used in the present disclosure, specify the presence of stated features, integers, steps, operations, elements, components or a combination thereof, but do not preclude the presence or addition of one or more other features, integers, steps, operations, elements, components, and/or groups thereof.

When it is mentioned that one component is “connected” or “accessed” to another component, it may be understood that the one component is directly connected or accessed to another component or that still other component is interposed between the two components. The terms such as ‘unit’, ‘module’, and the like refer to one or more units for processing at least one function or operation, which may be implemented by hardware, software, or a combination thereof. When a component, processor, controller, device, element, apparatus, or the like of the present disclosure is described as having a purpose or performing an operation, function, or the like, the component, processor, controller, device, element, unit, apparatus, or the like should be considered herein as being “configured to” meet that purpose or to perform that operation or function. Each controller, unit, module, component, device, element, and the like may separately embody or be included with a processor and a memory, such as a non-transitory computer readable media, as part of the apparatus. In the present disclosure, each of phrases such as “A or B”, “at least one of A and B”, “at least one of A or B”, “A, B or C”, “at least one of A, B and C”, “at least one of A, B or C” and “at least one of A, B, or C, or a combination thereof” may include any one or all possible combinations of the items listed together in the corresponding one of the phrases.

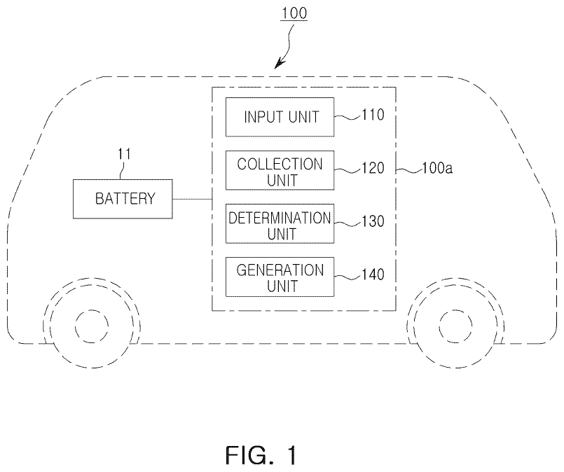

FIG. 1 schematically illustrates a vehicle system according to an embodiment of the present disclosure. Referring to FIG. 1, a vehicle system 100 may include a battery 11 and a vehicle information providing apparatus 100a. The vehicle information providing apparatus 100a may include an input unit 110, a collection unit 120, a determination unit 130, and a generation unit 140.

A vehicle including the vehicle system 100 may be a hybrid vehicle or an electric vehicle driving a motor using power supplied from the battery 11.

In addition, the battery 11 may supply power to other components included in the vehicle or the vehicle system 100. For example, the battery 11 may supply power to a display, an input module, a communication module, a sensor module, a memory, and a processor included in the vehicle or the vehicle system 100, and may operate the display, the input module, the communication module, the sensor module, the memory, and the processor included in the vehicle or the vehicle system 100.

The battery 11 included in the vehicle or the vehicle system 100 may include a secondary battery that may be charged or discharged. A state of charge (SoC) of the battery 11 may be increased by charging, or may be consumed or decreased by use.

The display included in the vehicle or the vehicle system 100 may display various types of pieces of information or contents. For example, the display may display a user interface receiving destination information of the vehicle and target SoC information of the battery 11 at a destination (i.e., the target SoC of the battery 11 when the vehicle reaches the destination).

In addition, the display may display charging plan information. The charging plan information may include a charging station at which charging is to be performed, among one or more charging stations located on a travel route, an amount of charging, and a period of time required for charging.

The input module included in the vehicle or the vehicle system 100 may receive or detect a user input. For example, the input module may detect a user input based on at least one of a touching operation of a user, a motion of the user, or a voice of the user.

The communication module included in the vehicle or the vehicle system 100 may communicate with an external device in a wired or wireless manner. For example, the communication module may collect travel environment information using vehicle to X (V2X) communication.

The sensor module may sense a state of the vehicle and an external environment. For example, the sensor module may include at least one of a wheel speed sensor sensing a wheel speed of the vehicle, a vehicle speed sensor sensing a travel speed of the vehicle, an accelerator position sensor (APS) interlocking with an operation of an accelerator pedal, a brake pedal sensor (BPS) interlocking with an operation of a brake pedal, a steering angle sensor (SAS) interlocking with an operation of a steering wheel, a temperature sensor sensing an internal or external temperature of the vehicle, an image sensor acquiring image data of the inside or the outside of the vehicle, or a distance sensor measuring a distance from the vehicle to an obstacle located in one direction.

The memory may store information for providing the user interface and the charging plan information.

The processor may control operations of other components included in the vehicle or the vehicle system 100. For example, the processor may control at least one of the battery, the display, the input module, the communication module, the sensor module, or the memory.

Referring to FIG. 1, the input unit 110 may receive the destination information of the vehicle and the target SoC information of the battery 11 included in the vehicle at the destination.

The destination information may include location information of a travel destination. The destination information may be determined based on at least one of, for example, location information of a place input by the user, location information of a place selected by the user through a search, location information of a place selected from a list of places stored in the memory, or location information of a place received from the external device.

The target SoC information may represent an SoC desired by the user when the vehicle reaches the destination. For example, the user may input a target SoC of 50%. In another example, the user may input the target SoC as 75%.

The collection unit 120 collect may travel environment information on the travel route determined based on the destination information. The collection unit 120 may collect the travel environment information using, for example, V2X communication.

The determination unit 130 may determine a charging plan establishment based condition, on target SoC information and travel environment information. The charging plan establishment condition may include a plurality of sub-conditions. For example, the charging plan establishment condition may include a first sub-condition, a second sub-condition, and a third sub-condition.

The determination unit 130 may determine the first sub-condition based on a total required amount of charging while traveling on the travel route. For example, the determination unit 130 may determine that the first sub-condition is satisfied when the total required amount of charging has a positive value.

The determination unit 130 may determine the second sub-condition based on minimum SoC information of the battery 11. The determination unit 130 may derive or determine first estimated SoC information of the battery when the vehicle travels through a section between a departure point and a nearest charging station from the departure point, among the one or more charging stations located on the travel route, and may determine that the second sub-condition is satisfied when the first estimated SoC information of the battery 11 has a value greater than that of the minimum SoC information of the battery 11.

The determination unit 130 may determine the third sub-condition based on the target SoC information. The determination unit 130 may derive or determine a first estimated amount of SoC consumption required for the vehicle to travel through a section between the nearest charging station from the destination, among the one or more charging stations located on the travel route, and may derive or determine second estimated SoC information, based on a difference between maximum SoC information of the battery 11 and the first estimated amount of SoC consumption. When the target SoC information has a value greater than that of the second estimated SoC information, the determination unit 130 may determine that the third sub-condition is satisfied.

When the first sub-condition, the second sub-condition, and the third sub-condition are all satisfied, the determination unit 130 may determine that the charging plan establishment condition is satisfied.

When the charging plan establishment condition is satisfied, the generation unit 140 may generate charging plan information on the travel route. The generation unit 140 may generate the charging plan information, based on a first rule or a second rule. The first rule and the second rule may be different from each other.

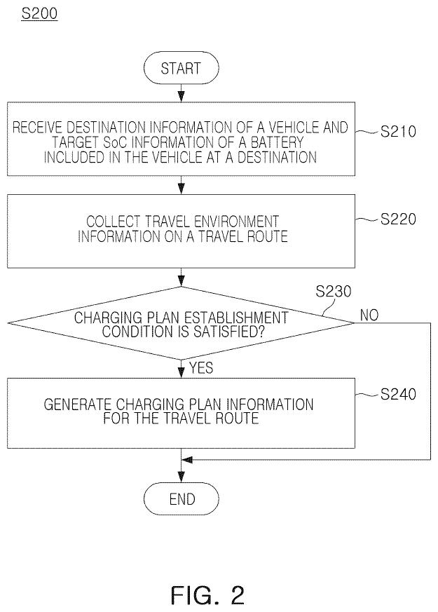

FIG. 2 is a flowchart illustrating a vehicle information providing method according to an embodiment of the present disclosure. The vehicle information providing method illustrated in FIG. 2 may be performed fully or partially by the vehicle system 100 illustrated in FIG. 1.

Referring to FIG. 2, a vehicle information providing method (S200) may include receiving destination information of a vehicle and target SoC information of a battery included in the vehicle at a destination (S210), collecting travel environment information on a travel route (S220), determining whether a charging plan establishment condition is satisfied (S230), and generating charging plan information for the travel route when the charging plan establishment condition is satisfied (S240).

In receiving the destination information of the vehicle and the target SoC information of the battery included in the vehicle at the destination (S210), destination information and target SoC information may be received from a user.

The destination information may include location information of a travel destination. The destination information may be determined based on at least one of, for example, location information of a place input by the user, location information of a place selected by the user through a search, location information of a place selected from a list of places stored in a memory, or location information of a place received from an external device.

The travel route may be a route on which the vehicle travels from a departure point to the destination, and may be derived or determined based on departure point information and destination information. The departure point information may be set by a current location of the vehicle or a user input.

When there is a plurality of travel routes on which the vehicle travels from the departure point to the destination, one travel route may be selected by the user, or one travel route may be selected according to a preset reference.

The target SoC information may represent an SoC of the battery desired by the user when the vehicle reaches the destination. The user may input the target SoC within a range of 0 to 100%. For example, the user may input a target SoC of 50%.

In collecting travel environment information on the travel route (S220), the travel environment information may be collected using V2X communication.

The travel environment information may include information on factors affecting energy consumed by the vehicle while the vehicle travels on the travel route. The travel environment information may include, for example, at least one of an average travel speed of the travel route, a location of a charging station, the number and output of chargers, whether a charger is available, a road environment, a slope, an altitude, or an external temperature. One or more charging stations may be located on the travel route.

In determining whether the charging plan establishment condition (S230) is satisfied, the charging plan establishment condition may be determined based on the target SoC information and the travel environment information.

The charging plan establishment condition may include a plurality of sub-conditions. For example, the charging plan establishment condition may include a first sub-condition, a second sub-condition, and a third sub-condition.

For example, determining whether the charging plan condition is satisfied (S230) may include determining the first sub-condition based on a total required amount of charging while traveling on the travel route, determining the second sub-condition based on minimum SoC information of the battery, and determining the third sub-condition based on the target SoC information.

The vehicle information providing method (S200) may further include deriving or determining a total required amount of charging for traveling on the travel route of the vehicle.

Deriving or determining the total required amount of charging may include deriving or determining one or more estimated amounts of SoC consumption of one or more unit sections (i.e., segments, portions, lengths, and the like) included in the travel route, and deriving or determining the total required amount of charging, based on the target SoC information, a sum of the one or more estimated amounts of SoC consumption of the one or more unit sections, and initial SoC information of the battery.

The travel route may include a plurality of unit sections. For example, the travel route may include a plurality of unit sections divided at regular distance intervals.

In another example, the travel route may include a plurality of unit sections divided at regular time intervals.

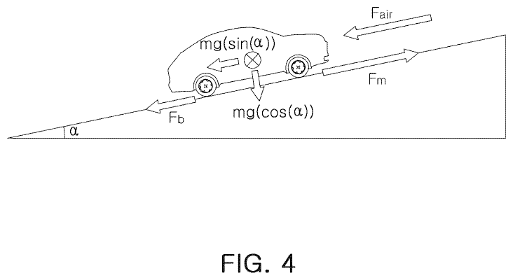

Hereinafter, a method for deriving or determining a total required amount of charging is described in detail with reference to FIGS. 4-6.

FIG. 4 is a diagram for explaining a method for calculating energy consumption when driving a vehicle. In FIG. 4, α may represent a slope of a unit section (i.e., slope of the road within the unit section), Fₘ may represent a wheel driving force of the unit section (i.e., wheel driving force of the vehicle within the unit section), F_{b} may represent a wheel braking force of the unit section (i.e., wheel braking force of the vehicle within the unit section), Fₐᵢᵣ may represent air resistance, m may represent a mass of the vehicle, and g may represent a gravitational acceleration.

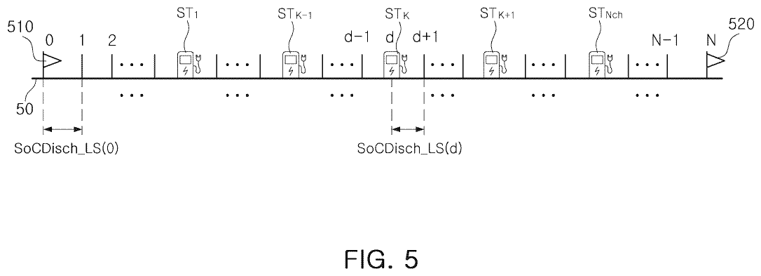

FIG. 5 schematically illustrates a travel route 50 determined based on a departure point 510 and a destination 520.

The travel route 50 may include a plurality of unit sections. In addition, one or more charging stations ST₁, . . . , STₖ₋₁, STₖ, STₖ₊₁, . . . , and ST_{Nch} may be located on the travel route 50.

In the example illustrated in FIG. 5, the travel route 50 may include N unit sections, and Nch charging stations may be located on the travel route 50. For example, the departure point 510 may be located at unit section boundary 0, the charging station STₖ may be located at unit section boundary d, and the destination 520 may be located at unit section boundary N.

The collected travel environment information may include average speed information of a vehicle in each unit section. For example, the travel environment information may include v(d), an average speed of a d-th unit section, and v(d+1), an average speed of a (d+1)-th unit section.

v(d+1), an average speed of the (d+1)-th unit section, may be represented using Equation 1.

$$v ( d + 1 ) = \sqrt{{v ( d )}^{2} + \frac{2 {L}_{s}}{{m}_{eq}} ( {F}_{m} ( d ) - {F}_{b} ( d ) - {F}_{r} ( d ) )} \qquad [ Equation 1 ]$$

In Equation 1, v(d) may represent an average speed of the d-th unit section, Lₛ may represent a distance of a unit section, m_{eq} may represent an equivalent mass of the vehicle, Fₘ(d) may represent a wheel driving force of the d-th unit section, F_{b}(d) may represent a wheel braking force of the d-th unit section, and Fᵣ(d) may represent a resistance of the d-th unit section.

Fᵣ(d), a resistance (force) of the d-th unit section, may be represented using Equation 2.

$${F}_{r} ( d ) = \frac{1}{2} {ρ}_{a} {C}_{d} {A}_{f} {v ( d )}^{2} + {m}_{eq} g ( sin ( α ( d ) ) + {C}_{r} cos ( α ( d ) ) \qquad [ Equation 2 ]$$

In Equation 2, ρ_{α} may represent an air density, C_{d} may represent an air resistance coefficient, A_{f} may represent an effective cross-sectional area of the vehicle, v(d) may represent an average speed of the d-th unit section, m_{eq} may represent an equivalent mass of the vehicle, g may represent a gravitational acceleration, α(d) may represent a slope of the d-th unit section, and Cᵣ may represent a cloud resistance coefficient.

According to Equations 1 and 2, Fₘ(d), a wheel driving force of the d-th unit section, and F_{b}(d), a wheel braking force of the d-th unit section, may be derived or determined.

E_{trac}(d), a driving energy required to travel through the d-th unit section, may be derived or determined using Equation 3.

$${E}_{trac} ( d ) = \frac{2 {L}_{s}}{n ( d )} ( {F}_{m} ( d ) - {F}_{b} ( d ) ) v ( d ) \qquad [ Equation 3 ]$$

In Equation 3, Lₛ may represent a distance of a unit section, n(d) may represent a motor driving efficiency of the d-th unit section, Fₘ(d) may represent a wheel driving force of the d-th unit section, F_{b}(d) may represent a wheel braking force of the d-th unit section, and v(d) may represent an average speed of the d-th unit section.

E_{consumption}(d), a travel consumption energy for traveling through the d-th unit section, may be derived or determined using Equation 4.

$${E}_{consumption} ( d ) = {E}_{trac} ( d ) + {E}_{aux} ( d ) \qquad [ Equation 4 ]$$

In Equation 4, E_{trac}(d) may represent a driving energy required to travel through the d-th unit section, and Eₐᵤₓ(d) may represent an auxiliary energy required to travel through the d-th unit section.

The auxiliary energy may represent an energy other than a driving energy required to drive a motor to travel through a unit section. The auxiliary energy may include an energy used for other components other than the motor, such as a vehicle thermal management device and an air conditioning device.

SoCDisch_Ls(d) illustrated in FIG. 5 may represent a travel consumption SoC in the d-th unit section. SoCDisch_Ls(d) may be derived or determined using Equation 5.

$$SoCDisch\_Ls ( d ) = \frac{{L}_{s}}{n ( d ) {E}_{cap}} ( {F}_{m} ( d ) - {F}_{b} ( d ) ) v ( d ) + \frac{{E}_{aux} ( d )}{{E}_{cap}} \qquad [ Equation 5 ]$$

In Equation 5, Lₛ may represent a distance of a unit section, n(d) may represent a motor driving efficiency of the d-th unit section, Fₘ(d) may represent a wheel driving force of the d-th unit section, F_{b}(d) may represent a wheel braking force of the d-th unit section, v(d) may represent an average speed of the d-th unit section, Eₐᵤₓ(d) may represent an auxiliary energy required to travel through the d-th unit section, and E_{cap} may represent a battery capacity.

In other words, SoCDisch_Ls(d) may be derived or determined as a value obtained by dividing Econsumption(d), a travel consumption energy for traveling through the d-th unit section, by the battery capacity.

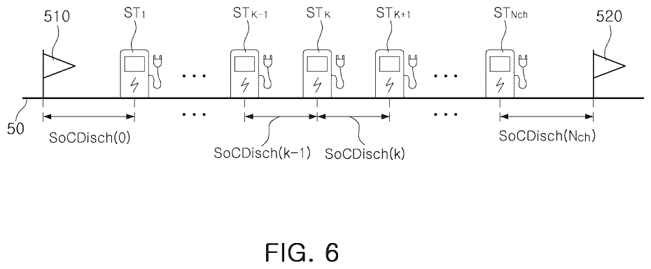

FIG. 6 illustrates the travel route 50 and the one or more charging stations ST₁, . . . , STₖ₋₁, STₖ, STₖ₊₁, . . . , and ST_{Nch} on the travel route 50 determined based on the departure point 510 and the destination 520 without illustrating the unit sections in FIG. 5.

In FIG. 6, SoCDisch(0) may represent a travel consumption SoC for traveling through a section from the departure point 510 to the charging station ST₁ (i.e., the first charging station along the driving path from the departure point 510). SoCDisch(0) may be derived or determined as a sum of travel consumptions SoC of unit sections included between the departure point 510 and the first charging station ST₁.

In addition, SoCDisch(k) may represent a travel consumption SoC for traveling through a section from a k-th charging station (STk) to a (k+1)-th charging station (STk+1).

SoCDisch(k) may be derived or determined using Equation 6.

$$SoCDisch ( k ) = {\sum }_{d = station\_dis t ( k )}^{station\_dist ( k + 1 )} SoCDisch\_Ls ( d ) \qquad [ Equation 6 ]$$

In Equation 6, station_dist(k) may represent an order of a unit section corresponding to a k-th charging station STₖ, and station_dist(k+1) may represent an order of a unit section corresponding to a (k+1)-th charging station STₖ₊₁.

In other words, SoCDisch(k) may be derived or determined as a value of a sum of travel consumptions SoC of unit sections included between the k-th charging station STₖ and the (k+1)-th charging station STₖ₊₁.

SoCDisch(0) may represent a travel consumption SoC for traveling through a section from the departure point 510 to the first charging station ST₁. SoCDisch(0) may be derived or determined as a value of a sum of travel consumptions SoCs of unit sections included between the departure point 510 and the first charging station ST₁.

In addition, SoCDisch(Nch) may represent a travel consumption SoC for traveling through a section from an Nch-th charging station ST_{Nch} to the destination 520. SoCDisch(Nch) may be derived or determined as a value of a sum of travel consumptions SoC of unit sections included between the Nch-th charging station ST_{Nch} and the destination 520.

SoCChTotal, a total required amount of charging, may be derived or determined using Equation 7.

$${SoCCh}_{Total} = SoCFinal - ( SoCInitial - {\sum }_{j = 0}^{{N}_{ch}} SoCDisch ( j ) ) \qquad [ Equation 7 ]$$

In Equation 7, SoCFinal may represent a destination target SoC, SoCInitial may represent an initial SoC of the battery, SoCDisch(j) may represent an SoC value derived or determined using Equation 6, and Nch may represent the number of charging stations located on the travel route.

Referring back to FIG. 2, in determining the first sub-condition, included in determining whether the charging plan establishment condition is satisfied (S230) in the vehicle information providing method (S200), it may be determined that the first sub-condition is satisfied when the total required amount of charging has a positive value.

The vehicle information providing method (S200) may further include deriving or determining first estimated SoC information of the battery.

The first estimated SoC information may include an estimated SoC value of the battery when the vehicle travels through a section between a departure point and a nearest charging station from the departure point (i.e., the first charging station), among one or more charging stations located on the travel route.

For example, in FIG. 6, the first estimated SoC information may be an estimated SoC value of the battery when traveling from the departure point 510 to the first charging station ST₁.

When an initial SoC of the battery is SoCInitial and a travel consumption SoC for traveling through a section from the departure point 510 to the first charging station ST₁ is SoCDisch(0), the first estimated SoC information may be derived or determined as SoCInitial-SoCDisch(0).

In determining the second sub-condition, it may be determined that the second sub-condition is satisfied when the first estimated SoC information has a value greater than that of the minimum SoC information of the battery.

The vehicle information providing method (S200) may further include deriving or determining a first estimated amount of SoC consumption required for the vehicle to travel through a section between a nearest charging station from a destination, among one or more charging stations located on the travel route, and the destination, and deriving or determining second estimated SoC information, based on a difference between maximum SoC information of the battery and the first estimated amount of SoC consumption.

For example, in FIG. 6, the first estimated amount of SoC consumption may be a travel consumption SoC for traveling from the Nch-th charging station ST_{Nch} to the destination 520.

When a maximum SoC of the battery is MaxSoC and the first estimated amount of SoC consumption is SoCDisch(Nch), a second estimated amount of SoC information may be derived or determined as (MaxSoC−SoCDisch(Nch).

In determining the third sub-condition, it may be determined that the third sub-condition is satisfied when the target SoC information has a value greater than that of the second estimated SoC information.

In determining whether the charging plan establishment condition is satisfied (S230), it may be determined that the charging plan establishment condition is satisfied when the first sub-condition, the second sub-condition, and the third sub-condition are all satisfied.

In other words, in determining whether the charging plan establishment condition is satisfied (S230), it may be determined that the charging plan establishment condition is satisfied when the total required amount of charging has a positive value, the first estimated SoC information has a value greater than that of the minimum SoC information of the battery, and the target SoC information has a value greater than the second estimated SoC information.

When the charging plan establishment condition is satisfied as a result of the determination (“YES” in S230), generating the charging plan information for the travel route (S240) may be performed in the vehicle information providing method (S200).

When the charging plan establishment condition is not satisfied as a result of the determination (“NO” in S230), the vehicle information providing method S200 may be terminated.

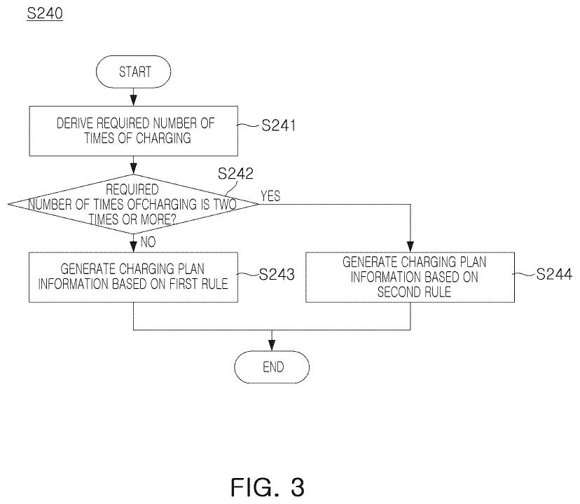

FIG. 3 is a detailed flowchart illustrating the generating of the charging plan information (S240) of the method of FIG. 2.

Generating the charging plan information (S240) may include deriving or determining the required number of times of charging (S241), and determining whether the required number of times of charging is two or more (S242).

In deriving or determining the required number of times of charging (S241), the required number of times of charging may be derived or determined based on the capacity of the battery and the total required amount of charging. For example, when the total required amount of charging has a value greater than that of the capacity of the battery, the required number of times of charging may be derived or determined as two or more times.

When the required number of times of charging is not two or more (“NO” in S242), i.e., when the required number of times of charging is once, generating the charging plan information, based on the first rule, (S243) may be performed.

Generating charging plan information, based on the first rule, (S243) may include deriving or determining a charging station at which charging is to be performed, among the one or more charging stations located on the travel route, based on the total required amount of charging and the minimum SoC information of the battery.

One of the one or more charging stations located on the travel route may be selected as the charging station at which charging is to be performed. For example, the charging station at which charging is to be performed may be determined as a charging station located immediately before a point at which an estimated SoC value of the battery is predicted to be less than a minimum SoC value of the battery due to an SoC of the battery being consumed as the vehicle travels on the travel route from the departure point 510 to the destination 520.

According to the first rule, when a charging station at which charging is to be performed is derived or determined, an amount of charging, corresponding to the total required amount of charging, may be performed at the charging station. In addition, a period of time required to perform an amount of charging, corresponding to the total required amount of charging, at the charging station may be derived or determined.

When the required number of times of charging is two or more (“YES” in S242), the generating the charging plan information, based on the second rule, (S244) may be performed. The second rule may be different from the first rule.

Generating the charging plan information, based on the second rule (S244), may include deriving or determining a first amount of charging to be performed at the nearest charging station from the destination, among the one or more charging stations located on the travel route, deriving or determining a first required amount of charging, based on a difference between the total required amount of charging and the first amount of charging, and deriving or determining a charging station at which charging is to be performed, among the one or more charging stations located on the travel route, and a second amount of charging, based on the first required amount of charging and the minimum SoC information of the battery.

In the example illustrated in FIG. 6, the nearest charging station from the destination, among the one or more charging stations located on the travel route, may be a last charging station ST_{Nch} located on the travel route.

In deriving or determining the first amount of charging to be performed at the nearest charging station from the destination, among the one or more charging stations located on the travel route, the first amount of charging SoCCh(N_{ch}) may be derived or determined using, for example, Equation 8.

$$SoCCh ( {N}_{ch} ) = SoCFinal - MinSoC + SoCDisch ( {N}_{ch} ) \qquad [ Equation 8 ]$$

In Equation 8, SoCFinal may represent a destination target SoC, MinSoC may represent a minimum SoC of the battery, and SoCDisch(N_{ch}) may be a travel consumption SoC for traveling through a section from the charging station ST_{Nch} to the destination 520.

In deriving or determining the first required amount of charging, based on a difference between the total required amount of charging and the first amount of charging, the first required amount of charge SoCCh₁ may be derived or determined using, for example, Equation 9.

$${SoCCh}_{1} = {SoCCh}_{Total} - SoCCh ( {N}_{ch} ) \qquad [ Equation 9 ]$$

In Equation 9, SoCCh_{Total} may represent a total required amount of charging, and SoCCh(N_{ch}) may represent a first amount of charging derived or determined using Equation 8.

When the first required amount of charging is derived or determined, a process similar to the process of generating the charging plan information, based on the first rule, may be performed.

For example, deriving or determining the charging station at which charging is to be performed, among the one or more charging stations located on the travel route, based on the total required amount of charging and the minimum SoC information of the battery, may be performed.

The charging station at which charging is to be performed may be selected from among the one or more charging stations located on the travel route, except for a last charging station. For example, the charging station at which charging is to be performed may be determined as a charging station located immediately before a point at which an estimated SoC value of the battery is predicted to be less than a minimum SoC value of the battery due to an SoC of the battery being consumed as the vehicle travels on the travel route from the departure point 510 to the destination 520.

When a charging station at which charging is to be performed is derived or determined, an amount of charging, corresponding to the first required amount of charging, may be performed at the charging station. In addition, a period of time required to perform an amount of charging, corresponding to the first required amount of charging, at the charging station may be derived or determined.

Generating the charging plan information, based on the second rule, (S244) may further include deriving or determining a second required amount of charging, based on a difference between the first required amount of charging and the second amount of charging.

Generating charging plan information, based on the second rule, (S244) may further include deriving or determining a charging station at which charging is to be performed, among the one or more charging stations located on the travel route, and a third amount of charging, based on the second required amount of charging and the minimum SoC information of the battery, when the second required amount of charging has a positive value.

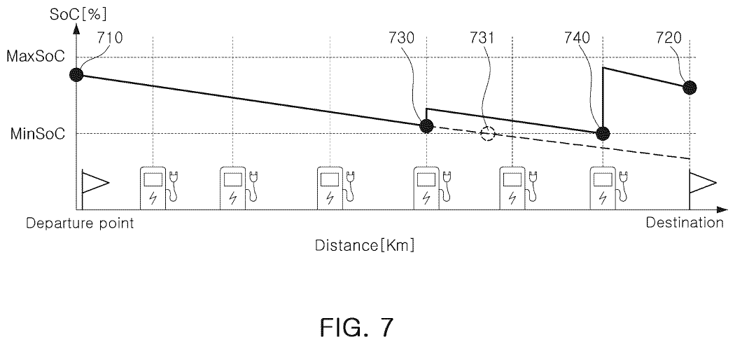

FIG. 7 is a diagram illustrating a method for generating charging plan information, based on a second rule.

When the required number of times of charging is two times, a first amount of charging to be performed at a nearest charging station (based on an SoC 740 at the nearest charging station) from a destination may be derived or determined. The first amount of charging may be derived or determined based on a destination target SoC 720, a minimum SoC of the battery, and a travel consumption SoC 740 for traveling through a section from the nearest charging station from the destination to the destination.

Subsequently, a first required amount of charging may be derived or determined based on a difference between the total required amount of charging and the first amount of charging to be performed at the nearest charging station from the destination. When the first required amount of charging is derived or determined, a process similar to the process of generating the charging plan information, based on the first rule, may be performed.

Referring to FIG. 7, it may be determined that charging is performed at a charging station located immediately before a point 731 at which an estimated SoC value 731 of the battery is predicted to be less than a minimum SoC value (MinSoC) of the battery due to an SoC of the battery being consumed as the vehicle travels on the travel route from the departure point 510 to the destination 520. Thus, as shown in FIG. 7, charging is performed twice in order to achieve the destination target SoC 720 and avoid SoC less than a minimum SoC value. For example, charging is first performed at a first point in time and a first distance having an estimated SoC 730 at one charging station and again at a second point in time and a second distance having an estimated SoC 740 at another charging station (i.e., the charging station nearest the destination).

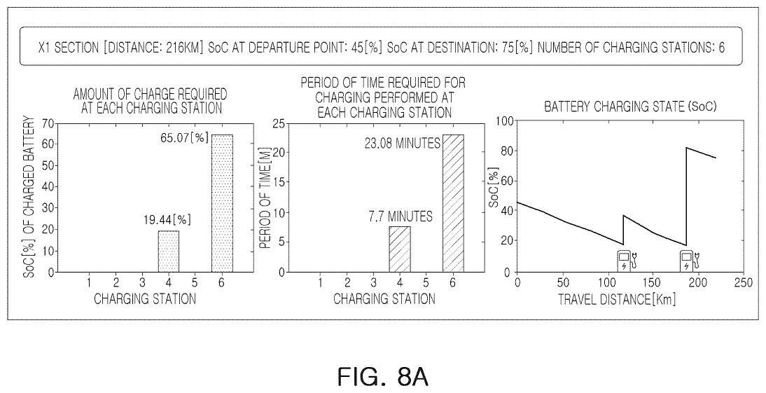

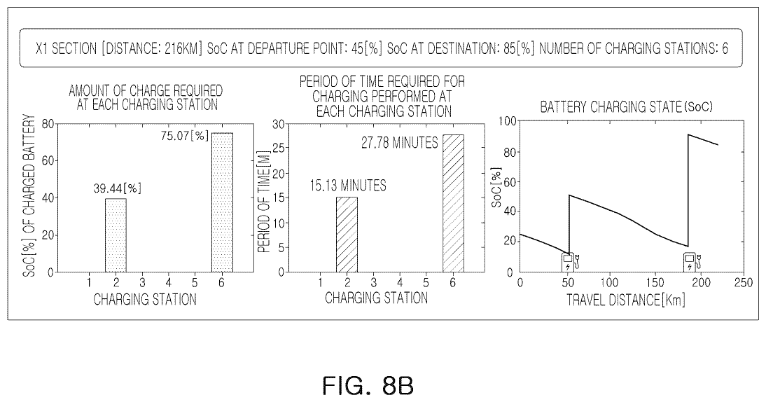

FIGS. 8A and 8B illustrate a display screen on which charging plan information generated by the vehicle information providing method according to an embodiment of the present disclosure is provided. The charging plan information may include a charging station at which charging is to be performed, among one or more charging stations located on a travel route, an amount of charging, and a period of time required for charging.

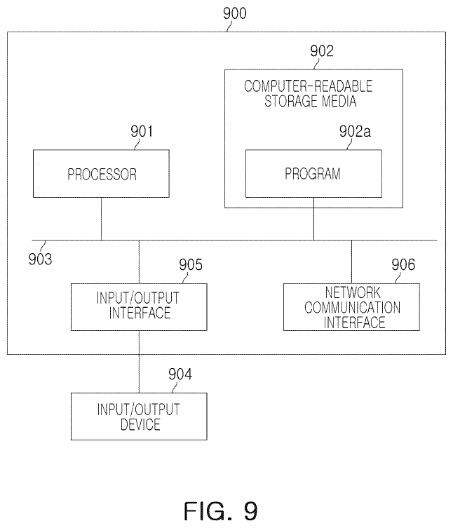

FIG. 9 is a block diagram illustrating a computing device 900 capable of fully or partially implementing a vehicle system according to an embodiment of the present disclosure, and may entirely or partially include the vehicle system 100 illustrated FIG. 1.

As illustrated in FIG. 9, the computing device 900 may include at least one processor 901, a computer-readable storage medium 902, and a communication bus 903.

The processor 901 may cause the computing device 900 to operate according to the embodiments described above. For example, the processor 901 may execute one or more programs stored in the computer-readable storage medium 902. The one or more programs may include one or more computer-executable instructions. When executed by the processor 901, the one or more computer-executable instructions may be configured to cause the computing device 900 to perform operations according to embodiments.

The computer-readable storage medium 902 may be configured to store the computer-executable instructions or program code, program data, and/or other suitable forms of information. A program 902a, stored in the computer-readable storage medium 902, may include a set of instructions executable by the processor 901. In an embodiment, the computer-readable storage medium 902 may be a memory (a volatile memory such as a random access memory, a non-volatile memory, or any suitable combination thereof), one or more magnetic disk storage devices, optical disk storage devices, flash memory devices, other types of storage media that are accessible by the computing device 900 and are capable of storing desired information, or any suitable combinations thereof.

The communication bus 903 may interconnect various other components of the computing device 900, including the processor 901 and the computer-readable storage medium 902.

The computing device 900 may also include one or more input/output interfaces 905 providing an interface for one or more input/output devices 904, and one or more network communication interfaces 906. The input/output interface 905 and the network communication interface 906 may be connected to the communication bus 903.

The network communication interface 906 may be an interface for in-vehicle communication or an interface for communication between a vehicle and a device other than the vehicle, and may include, for example, a controller area network (CAN), a media oriented systems transport (MOST) network, a local interconnect network (LIN), and/or X-by-Wire (Flexray), Wi-Fi, Bluetooth, Near Field Communication (NFC), or Radio-Frequency Identification (RFID). A network may be one of a cellular network, for example, a global system for mobile communications (GSM), an enhanced data rate for GSM evolution (EDGE), a general packet radio service (GPRS), a code division multiple access (CDMA), a time division-CDMA (TD-CDMA), a universal mobile telecommunications system (UMTS), or long-term evolution (LTE), or another cellular network.

The input/output device 904 may be connected to other components of the computing device 900 through the input/output interface 905. The example input/output device 904 may include input devices (or input modules) such as a pointing device (such as a mouse or trackpad), a keyboard, a touch input device (such as a touchpad or touchscreen), a voice or sound input device, various types of sensor devices and/or photographing devices, and/or output devices such as a display device, a printer, a speaker, and/or a network card. The example input/output device 904 may be included in the computing device 900 as a component included in the computing device 900, or may be connected to the computing device 900 as a device, distinct from the computing device 900.

Embodiments of the present disclosure may include a program for performing the methods described herein on a computer, and a computer-readable recording medium including the program. The computer-readable recording medium may include, alone or in combination with program instructions, local data files, local data structures, and the like. The medium may be those specially designed and constructed for the purposes of the embodiments, or may be of the well-known kind and available to those having skill in the computer software arts. Examples of the computer-readable medium include magnetic media such as hard disks, floppy disks, and magnetic tape, optical media such as a Compact Disc-Read Only Memory (CD ROM) and Digital Versatile Disc (DVD), magneto-optical media such as optical discs, and hardware devices that are specially configured to store and perform program instructions, such as read-only memory (ROM), random access memory (RAM), flash memory, and the like. Examples of the program may include both a machine code, such as a code produced by a compiler, and a higher-level code that may be executed by the computer using an interpreter.

While embodiments have been shown and described above, it should be apparent to those having ordinary skill in the art that modifications and variations could be made without departing from the scope of the present disclosure as defined by the appended claims.

What is claimed is:

1. A method for providing vehicle information, performed by a computing device including a processor and a storage medium storing instructions executable by the processor, the method comprising:
receiving destination information of a vehicle and target state of charge (SoC) information of a battery included in the vehicle at a destination;
collecting travel environment information on a travel route determined based on the destination information;
determining a charging plan establishment condition, based on the target SoC information and the travel environment information; and
generating charging plan information for the travel route based on the charging plan establishment condition being satisfied.

2. The method for claim 1, wherein determining the charging plan establishment condition includes:
determining a first sub-condition based on a total required amount of charging for traveling on the travel route;
determining a second sub-condition based on minimum SoC information of the battery; and
determining a third sub-condition based on the target SoC information,
wherein the charging plan establishment condition is determined as being satisfied, based on the first sub-condition, the second sub-condition, and the third sub-condition being satisfied.

3. The method for claim 2, further comprising:
determining the total required amount of charging,
wherein determining the first sub-condition includes determining that the first sub-condition is satisfied based on the total required amount of charging being a positive value.

4. The method for claim 3, wherein determining the total required amount of charging includes:
determining one or more estimated amounts of SoC consumption of one or more unit sections included in the travel route; and
determining the total required amount of charging, based on the target SoC information, a sum of the one or more estimated amounts of SoC consumption of the one or more unit sections, and initial SoC information of the battery.

5. The method for claim 2, further comprising:
determining first estimated SoC information of the battery based on the vehicle traveling through a section between a departure point and a nearest charging station from the departure point, among one or more charging stations located on the travel route,
wherein determining the second sub-condition includes determining that the second sub-condition is satisfied based on the first estimated SoC information having a value greater than a value of the minimum SoC information of the battery.

6. The method for claim 2, further comprising:
determining a first estimated amount of SoC consumption required for the vehicle to travel through a section between a nearest charging station from a destination, among one or more charging stations located on the travel route, and the destination; and
determining second estimated SoC information, based on a difference between maximum SoC information of the battery and the first estimated amount of SoC consumption,
wherein determining the third sub-condition includes determining that the third sub-condition is satisfied, based on the target SoC information having a value greater than a value of the second estimated SoC information.

7. The method for claim 2, wherein
generating the charging plan information includes determining a required number of times of charging, based on a capacity of the battery and the total required amount of charging, and
generating the charging plan information further includes:
generating the charging plan information based on a first rule, based on the required number of times of charging being once; or
generating the charging plan information based on a second rule different from the first rule, based on the required number of times of charging being two or more.

8. The method for claim 7, wherein generating the charging plan information based on the first rule includes determining a charging station at which charging is to be performed, among one or more charging stations located on the travel route, based on the total required amount of charging and the minimum SoC information of the battery.

9. The method for claim 7, wherein generating the charging plan information based on the second rule includes:
determining a first amount of charging to be performed at a nearest charging station from a destination, among one or more charging stations located on the travel route;
determining a first required amount of charging, based on a difference between the total required amount of charging and the first amount of charging; and
determining a charging station at which charging is to be performed, among the one or more charging stations located on the travel route, and a second amount of charging, based on the first required amount of charging and the minimum SoC information of the battery.

10. The method for claim 9, wherein generating the charging plan information based on the second rule includes:
determining a second required amount of charging, based on a difference between the first required amount of charging and the second amount of charging; and
determining a charging station at which charging is to be performed, among the one or more charging stations located on the travel route, and a third amount of charging, based on the second required amount of charging and the minimum SoC information of the battery, based on the second required amount of charging having a positive value.

11. The method for claim 1, wherein the charging plan information includes a charging station at which charging is to be performed, among one or more charging stations located on the travel route, an amount of charging, and a period of time required for charging.

12. An apparatus for providing vehicle information, the apparatus comprising:
a processor; and
a storage medium storing instructions executable by the processor,
wherein the processor, by executing the instructions, is configured to:
receive destination information of a vehicle and target state of charge (SoC) information of a battery included in the vehicle at a destination;
collect travel environment information on a travel route determined based on the destination information;
determine a charging plan establishment condition, based on the target SoC information and the travel environment information; and
generate charging plan information for the travel route based on the charging plan establishment condition being satisfied.

13. The apparatus of claim 12, wherein the processor is further configured to:
determine a first sub-condition based on a total required amount of charging for traveling on the travel route;
determine a second sub-condition based on minimum SoC information of the battery;
determine a third sub-condition based on the target SoC information; and
determine that the charging plan establishment condition is satisfied, based on the first sub-condition, the second sub-condition, and the third sub-condition being satisfied.

14. The apparatus of claim 13, wherein the processor is further configured to:
determine the total required amount of charging; and
determine that the first sub-condition is satisfied, based on the total required amount of charging having a positive value.

15. The apparatus of claim 14, wherein the processor is further configured to:
determine one or more estimated amounts of SoC consumption of one or more unit sections included in the travel route; and
determine the total required amount of charging, based on the target SoC information, a sum of the one or more estimated amounts of SoC consumption of the one or more unit sections, and initial SoC information of the battery.

16. The apparatus of claim 13, wherein the processor is further configured to:
determine first estimated SoC information of the battery based on the vehicle traveling through a section between a departure point and a nearest charging station from the departure point, among one or more charging stations located on the travel route; and
determine that the second sub-condition is satisfied based on the first estimated SoC information having a value greater than a value of the minimum SoC information of the battery.

17. The apparatus of claim 13, wherein the processor is further configured to:
determine a first estimated amount of SoC consumption required for the vehicle to travel through a section between a nearest charging station from a destination, among one or more charging stations located on the travel route, and the destination;
determine second estimated SoC information, based on a difference between maximum SoC information of the battery and the first estimated amount of SoC consumption; and
determine that the third sub-condition is satisfied, based on the target SoC information having a value greater than a value of the second estimated SoC information.

18. The apparatus of claim 13, wherein the processor is further configured to:
determine a required number of times of charging, based on a capacity of the battery and the total required amount of charging;
generate the charging plan information based on a first rule, based on the required number of times of charging being once; and
generate the charging plan information based on a second rule different from the first rule, based on the required number of times of charging being two or more.

19. The apparatus of claim 12, wherein the charging plan information includes a charging station at which charging is to be performed, among one or more charging stations located on the travel route, an amount of charging, and a period of time required for charging.

20. A vehicle system comprising:
a battery;
a display;
an input module; and
a processor configured to:
cause the display to display a user interface receiving destination information of a vehicle and target state of charge (SoC) information of the battery at a destination;
collect travel environment information on a travel route determined based on the destination information;
determine a charging plan establishment condition, based on the target SoC information and the travel environment information;
generate charging plan information for the travel route based on the charging plan establishment condition being satisfied; and
cause the display to display the charging plan information.
